(19) United States
(12) Patent Application Publication
(10) Pub. No.: US 2022/0004812 A1
(43) Pub. Date: Jan. 6, 2022

(54) IMAGE PROCESSING METHOD, METHOD FOR TRAINING PRE-TRAINING MODEL, AND ELECTRONIC DEVICE

(71) Applicant: BEIJING BAIDU NETCOM SCIENCE AND TECHNOLOGY CO., LTD., BEIJING (CN)

(72) Inventor: Chao Li, Beijing (CN)

(73) Assignee: BEIJING BAIDU NETCOM SCIENCE AND TECHNOLOGY CO., LTD., BEIJING (CN)

(21) Appl. No.: 17/479,147

(22) Filed: Sep. 20, 2021

(51) Int. Cl. G06K 9/62; G06K 9/00

(52) U.S. Cl. CPC G06K 9/6256; G06K 9/00744; G06N 3/08; G06K 9/00765; G06K 9/627

(57) ABSTRACT

An image processing method, a method for training a pre-training model, and an electronic device are provided. An implementation solution is described as follows. A pre-training model is obtained after a training process based on a plurality of training images, in which image features output by the pre-training model satisfy that a first image feature distance and a second image feature distance have a minimum difference. Furthermore, according to the general pre-training model and a target image processing task, a corresponding image processing model is generated.

### CROSS-REFERENCE TO RELATED APPLICATIONS

This application claims the benefit of priority to Chinese Application No. 202011249923.2, filed on Nov. 10, 2020, the contents of which are incorporated herein by reference in their entirety.

### TECHNICAL FIELD

The disclosure relates to a field of image processing, particular to a deep learning technology and a computer vision technology, and more particular to an image processing method, a method for training a pre-training model, an image processing apparatus, an apparatus for training a pre-training model and an electronic device.

### BACKGROUND

Image processing technology based on a neural network has been developed for many years. According to image processing requirements, a trained image processing model is configured to process and recognize images. However, different image processing tasks have different image processing requirements, if a constant image processing model is used for image processing, the image processing requirements in different scenarios may not be met. Therefore, how to improve an effect of image processing is a technical problem to be solved urgently.

### SUMMARY

The disclosure provides an image processing method, a method for training a pre-training model, and an electronic device.

Embodiments of a first aspect of the disclosure provide an image processing method. The method includes: obtaining a pre-training model after a training process based on a plurality of training images, in which image features output by the pre-training model satisfy that a first image feature distance and a second image feature distance have a minimum difference, in which the first image feature distance is a distance among image features of a plurality of training images extracted from a same video clip, and the second image feature distance is a distance among image features of a plurality of training images extracted from different video clips; generating an image processing model configured to perform a target image processing task based on the pre-training model; and performing the target image processing task for a target image by using the image processing model.

Embodiments of a second aspect of the disclosure provide a method for training a pre-training model. The method includes: obtaining a plurality of video clips; extracting a plurality of training images from the plurality of video clips to obtain a training set, in which at least two training images are extracted from each of the plurality of video clips; and performing a plurality of rounds of training on the pre-training model for image feature extraction based on the training set. Each round of training includes: selecting training images extracted from at least two video clips from the training set; inputting the selected training images into the pre-training model to obtain image features; determining a first image feature distance among a plurality of training images belonging to a same video clip and determining a second image feature distance among a plurality of training images belonging to different video clips based on the image features of the selected training images, and adjusting parameters of the pre-training model based on the first image feature distance and the second image feature distance to cause that the first image feature distance and the second image feature distance have a minimum difference.

Embodiments of a third aspect of the disclosure provide an electronic device. The electronic device includes: at least one processor and a memory communicatively coupled to the at least one processor. The memory stores instructions executable by the at least one processor, and when the instructions are executed by the at least one processor, the at least one processor executes the image processing method according to embodiments of the first aspect or the method for training a pre-training model according to embodiments of the second aspect.

It should be understood that the content described in this section is not intended to identify key or important features of the embodiments of the disclosure, nor is it intended to limit the scope of the disclosure. Additional features of the disclosure will be easily understood based on the following description.

### BRIEF DESCRIPTION OF THE DRAWINGS

The drawings are used to better understand the solution and do not constitute a limitation to the disclosure, in which:

FIG. 1 is a flowchart of an image processing method according to an embodiment of the disclosure.

FIG. 2 is a flowchart of an image processing method according to another embodiment of the disclosure.

FIG. 3 is a schematic diagram of an image processing model according to an embodiment of the disclosure.

FIG. 4 is a flowchart of a method for training a pre-training model according to an embodiment of the disclosure.

FIG. 5 is a block diagram of an image processing apparatus according to an embodiment of the disclosure.

FIG. 6 is a block diagram of an apparatus for training a pre-training model according to an embodiment of the disclosure.

FIG. 7 is a block diagram of an electronic device according to an embodiment of the disclosure.

### DETAILED DESCRIPTION

The following describes the exemplary embodiments of the disclosure with reference to the accompanying drawings, which includes various details of the embodiments of the disclosure to facilitate understanding, which shall be considered merely exemplary. Therefore, those of ordinary skill in the art should recognize that various changes and modifications can be made to the embodiments described herein without departing from the scope and spirit of the disclosure. For clarity and conciseness, descriptions of well-known functions and structures are omitted in the following description.

An image processing method, a method for training a pre-training model, an image processing apparatus, an apparatus for training a pre-training model and an electronic device according to the embodiments are described in detail with reference to the drawings.

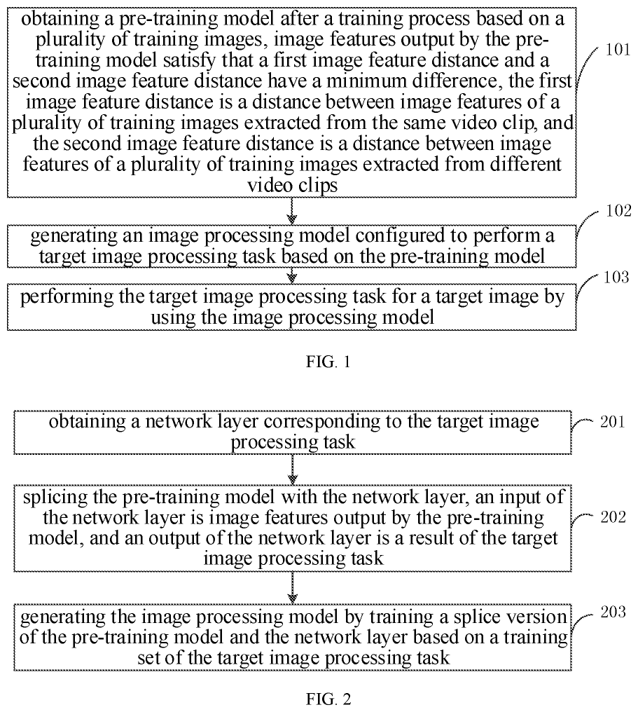

FIG. 1 is a flowchart of an image processing method according to an embodiment of the disclosure.

As illustrated in FIG. 1, the method includes the following steps.

At block 101, a pre-training model is obtained after a training process based on a plurality of training images. Image features output by the pre-training model satisfy that a first image feature distance and a second image feature distance have a minimum difference, in which the first image feature distance is a distance among image features of a plurality of training images extracted from a same video clip, and the second image feature distance is a distance among image features of a plurality of training images extracted from different video clips.

In the embodiment, the pre-training model may be trained through deep learning. Compared to other machine learning methods, deep learning performs better on the large data set. A plurality of training images are extracted from a plurality of video clips to obtain a training set, the training set is input into the pre-training model, and parameters of the pre-training model are continuously adjusted, so as to perform iterative training on the pre-training model till an output result of the pre-training model meets a preset threshold, then the training process is ended. A general pre-training model is generated based on a large amount of image data, and an efficiency of generating a corresponding target image processing model may be improved based on the general pre-training model subsequently.

The method for training the pre-training model will be described in detail in the following embodiments, which is not repeated here.

At block 102, an image processing model configured to perform a target image processing task is generated based on the pre-training model.

The target image processing task includes an image classification task, a target detection task or an object recognition task.

In the disclosure, after the pre-training model is generated, since the pre-training model is a pre-generated general model, an image processing model correspondingly performing the target image processing task can be quickly generated according to the image set corresponding to the target image processing task, such that an efficiency of generating the image processing model corresponding to the target image processing task is improved.

The image processing model may be a Convolutional Neural Networks (CNN) model, or a Deep Neural Networks (DNN) model, which is not limited herein.

At block 103, the target image processing task is performed for a target image by using the image processing model.

The image processing model in the embodiment is an image processing model corresponding to the target image processing task that is generated based on a general pre-training model obtained by pre-training, such that a generation efficiency of the model is improved. Meanwhile, the image processing model is configured to perform the target image processing task for the target image, which improves an execution effect and a processing efficiency of the target image processing task.

According to the image processing method, a pre-training model is obtained after a training process based on a plurality of training images, so that the image features output by the pre-training model satisfy that the first image feature distance and the second feature characteristic distance have a minimum difference. Furthermore, according to the general pre-training model and the target image processing task, the corresponding image processing model is generated, which improves the generation efficiency of the image processing model corresponding to the target image processing task. The generated image processing model is configured to perform the target image processing task for the target image. Since the image processing model corresponds to the target image processing task, an effect and an efficiency of image processing are improved.

In the above embodiments, in order to improve the efficiency of image processing, the image processing model corresponding to the target image processing task is generated according to the target image processing task and the pre-training model. As a possible implementation, the pre-training model is trained based on the image processing task to generate the image processing model corresponding to the image processing task to improve the efficiency of image processing. As another possible implementation, after splicing the pre-training model with a network layer corresponding to the target processing task, the corresponding image processing model is obtained through training, so as to improve an efficiency of generating the image processing model and an effect of image processing.

Based on the above embodiments, embodiments of the present disclosure provide another image processing method. FIG. 2 is a flowchart of an image processing method according to another embodiment of the disclosure. As illustrated in FIG. 2, block 102 includes the following steps.

At block 201, a network layer corresponding to a target image processing task is obtained. In the disclosure, a correspondence between network layers and target image processing tasks may be determined in advance, and the network layer may be obtained based on the correspondence, such that the obtained network layer corresponds to the target image processing task.

In a scenario, the target image processing task is an image classification task, and the corresponding network layer is a classification layer, which is configured to classify the target image, for example, to determine a corresponding category of vehicle contained in the image to be classified, such as, cars, SUVs and so on.

In another scenario, the target image processing task is a target detection task, and the corresponding network layer is a detection network, which is configured to identify a target object contained in the target image, for example, for the target image to be processed, it is detected whether the image contains an obstacle, or it is detected whether a plurality of images contain the same target object.

In yet another scenario, the target image processing task is an object recognition task, and the corresponding network layer is configured to recognize objects in the image. For example, for the target image to be processed, types of objects contained in different areas of the image or categories of objects contained in the image are recognized.

At block 202, the pre-training model is spliced with the network layer, in which an input of the network layer is image features output by the pre-training model, and an output of the network layer is a processing result of the target image processing task.

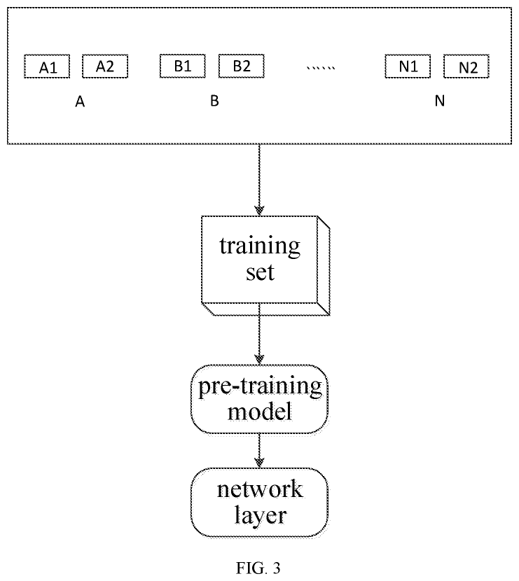

In this embodiment, after the general pre-training model is generated, the pre-training model is spliced with the network layer corresponding to the target image processing task. As illustrated in FIG. 3, the pre-training model obtained after the training process and the network layer are spliced together to obtain the image processing model to be trained. The image features output by the pre-training model are input to the network layer, and the output of the network layer is configured as a processing result of the target image processing task.

At block 203, the image processing model is obtained by training a splice version of the pre-training model and the network layer based on a training set of the target image processing task.

In the embodiment, for different target image processing tasks, in order to rapidly obtain the image processing model corresponding to the target image processing task, the training set corresponding to the target image processing task is used for training the splice version of the pre-training model and the network layer to obtain the image processing model. That is, the image processing model obtained by training corresponds to the target image processing task, and the general pre-processing model obtained by pre-training is spliced with the corresponding network layer, and then training is performed. As a possible implementation, according to requirements of the target image processing task, the parameters of the network layer may be adjusted to improve an efficiency of training the image processing model, while meeting the processing requirements of different target image processing tasks and meeting the processing requirements in different scenarios.

In the image processing method of the embodiment, the general pre-processing model obtained based on pre-training is spliced with the corresponding network layer, and training is performed. The input of the network layer is the image features output by the pre-training model, and the output of the network layer is the processing result of the target image processing task. Since the training is mainly for the network layer corresponding to the target image processing task, the amount of training data is small, which improves an efficiency of training the corresponding image processing model.

In order to implement the above embodiments, embodiments further provide a method for training a pre-training model.

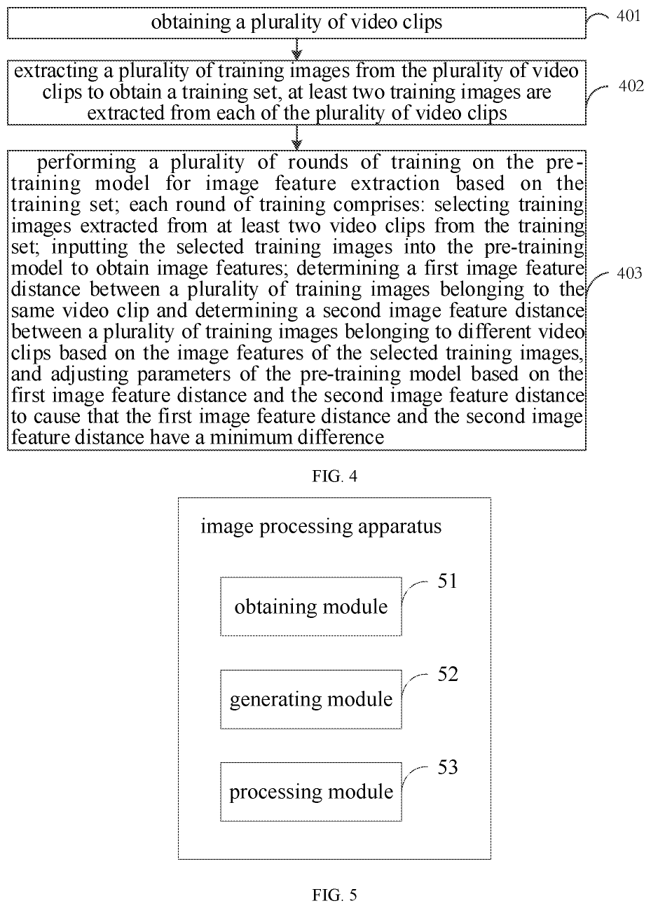

FIG. 4 is a flowchart of a method for training a pre-training model according to an embodiment of the disclosure. As illustrated in FIG. 4, the method includes the following steps.

At block 401, a plurality of video clips are obtained.

In a possible implementation, at least one video is obtained, and each video may be randomly divided into a plurality of video clips.

As a possible implementation, in order to obtain more video clips, a plurality of videos are obtained, and segmentation is performed according to a content difference between adjacent image frames in each video to obtain a plurality of video clips of each video. That is, when segmentation is performed on each video, frames in the video clip obtained by the segmentation have continuous change in contents, which improves continuity of the frames in the video clip.

In another possible implementation, a video is obtained, and segmentation is performed according to the content difference between adjacent image frames in the video to obtain a plurality of video clips. That is, when the segmentation is performed on the video, frames in the segmented video clip have continuous change in contents, which improves continuity of the frames in the video clip.

As illustrated in FIG. 3, A, B, . . . N represent different video clips.

In a scenario, different video clips may be obtained by the segmentation performed on one video clip. In another scenario, different video clips may be obtained by the segmentation performed on a plurality of video clips, which may be flexibly set according to requirements of the training scenario, and is not limited herein.

At block 402, a plurality of training images are extracted from the plurality of video clips to obtain a training set. At least two training images are extracted from each of the plurality of video clips.

In the embodiment, the training set is composed of a plurality of frames of training images extracted from a plurality of video clips. As a possible implementation, a certain number of frames of training images are randomly selected from each video clip, and the training set is generated by the plurality of training images extracted from the plurality of video clips. At least two frames of training images are extracted from each video clip.

As another possible implementation, in order to improve an effect of model training, the same number of frames of training images may be extracted from each video clip, which improves uniformity of the frame number distribution for each video clip in the training set. The pre-training model is trained through the training set, so that the video clips have the same weight ratio in determining the model parameters, thereby improving a subsequent training effect of the pre-training model.

As illustrated in FIG. 3, A, B, and N represent different video clips. In the embodiment, for example, 2 frames are extracted from each video clip as the training images, A1 and A2 are two frames in video clip A, B1 and B2 are two frames in video clip B, and N1 and N2 are two frames in video clip N.

For example, three video clips are obtained from video X, namely video clips A, B, and C. As illustrated in FIG. 3, N is C, and two frames are extracted from each video clip.

In the video clip A, the two extracted image frames are A1 and A2, and A1 and A2 are two consecutive frames. In the video clip B, two extracted image frames are B1 and B2, and B1 and B2 are two consecutive frames. In the video clip C, the two extracted image frames are C1 and C2, and C1 and C2 are two consecutive frames. Furthermore, a training set is generated based on the image frames A1, A2, B1, B2, C1, and C2.

It should be noted that in a practical application, the number of training images contained in the training set is not limited to 6 as described in the embodiment, which may be flexibly set according to the accuracy requirement of training.

At block 403, a plurality of rounds of training are performed on the pre-training model for image feature extraction based on the training set. Each round of training includes: selecting training images extracted from at least two video clips from the training set; inputting the selected training images into the pre-training model to obtain image features; determining a first image feature distance among a plurality of training images belonging to a same video clip and determining a second image feature distance among a plurality of training images belonging to different video clips based on the image features of the selected training images, and adjusting parameters of the pre-training model based on the first image feature distance and the second image feature distance to cause that the first image feature distance and the second image feature distance have a minimum difference, so that the pre-training model obtained after the training process may be determined as a general pre-training model which may recognize an association relation of different video clips.

In the embodiment, a plurality of rounds of training are performed on the pre-training model based on the training set. In each round of training, an effect of training is determined according to a recognition result to adjust the parameters of the pre-training model till the model converges, so that the pre-training model may accurately generate the image features of the training images. In the embodiment, based on the training images in the training set, a general pre-training model is obtained by pre-training, and the image features output by the pre-training model are used as a general result of image recognition for facilitating combination with the subsequent target image recognition task, such that the image processing model corresponding to the target image recognition task is may be quickly obtained, and thus improving a generation efficiency of the image processing model.

It should be understood that since the training set includes a plurality of video clips belonging to the same video and a plurality of video clips belonging to different videos, the training images extracted from at least two video clips are selected from the training set during each round of training. The two video clips may belong to the same video or different videos, so that the extracted training images can be used to identify the association relation of different video clips, and the general pre-training model which has improved robustness can be obtained.

According to the method for training a pre-training model according to embodiments of the disclosure, at least two frames of training images are extracted from each of the plurality of obtained video clips respectively to obtain a plurality of frames of training images which form the training set. The training set is used to perform a plurality of rounds of training on the pre-training model used for image feature extraction. In each round of training, the image features are obtained from the training images, the first image feature distance among images is obtained based on the image features of the images belonging to the same video clip, and the second image feature distance among images is obtained based on the image features of the images belonging to different video clips. The parameters of the pre-training model are constantly adjusted to minimize the difference between the first image feature distance and the second image feature distance. In this way, the training of the general pre-training model can be realized and a reliability of image features recognized by the pre-training model is improved.

Based on the above embodiments, embodiments further provide another method for training a pre-training model. In order to improve calculation precision of the first image feature distance, the determination of the first image feature distance among training images belonging to the same video segment is specifically described, which may be implemented through the following steps.

For the training images inputted into the pre-training model in the round of training, an intra-class feature distance among image features of a plurality of training images belonging to the same video clip is determined. For the at least two video clips selected from the training set during the round of training, a sum of the intra-class feature distances is determined to obtain the first image feature distance. The first image feature distance indicates an association relation among image features of different training images belonging to the same video clip.

In a possible implementation of the embodiments of the disclosure, for example, the selected training images i1 and i2 belong to the same video clip i, and the training images i1 and i2 are input into the pre-training module to obtain image features of respective training images, which are denoted as hi1 and hi2. Further, the intra-class feature distance d (i1, i2) between the image features hi1 and hi2 of the training images i1 and i2 belonging to the same video clip i is calculated. Furthermore, for at least two video clips selected from the training set in the round of training, the sum of the intra-class feature distances is determined to obtain the first image feature distance dist(intra), which is implemented by the following formula:

$$dist ( intra ) = {\sum }_{i = 1}^{n} d ( {h}_{i 1} , {h}_{i 2} )$$

where i represents a video clip, that is, the video clip is represented by a natural number from 1 to n, and n is greater than or equal to 2.

It should be noted that, in the embodiment, two training images are selected from each video clip. In actual applications, the number of training images selected from each video clip is flexibly set according to training requirements, which is not limited herein. For example, when more than two training images are selected from each video clip, a distance between image features of each two of the training images extracted from the same video clip may be obtained, and then a sum or an average of the obtained distances may be determined as the intra-class feature distance for the video clip.

In another possible implementation of the embodiments of the disclosure, in order to meet requirements of different scenarios, the image features of different training images belonging to the same video clip may be classified. That is, the image features of different training images are classified into different categories to achieve refined feature recognition. For example, image features belonging to a category of people, image features belonging to the building, or image features belonging to the nose are determined. For different training images, an intra-category feature distance between the image features of any two training images that correspond to the same category is obtained. The sum of all the intra-category feature distances is obtained as the intra-class feature distance. Further, for at least two video clips selected from the training set in the round of training, the sum of the intra-class feature distances are determined to obtain the first image feature distance. In this way, a refined calculation of the first image feature distance is realized and a calculation accuracy of the first image feature distance is improved.

It should be noted that, the image feature distance may be calculated according to a Euclidean distance or a cosine distance.

Based on the above embodiments, embodiments further provide another method for training a pre-training model. In order to improve calculation precision of the second image feature distance, the determination of the second image feature distance among training images belonging to different video clips is specifically described, which may be implemented through the following steps.

For the training images inputted into the pre-training model in the round of training, an inter-class feature distance among image features of different training images belonging to different video clips is determined. For at least two video clips selected from the training set in the round of training, a sum of the inter-class feature distances is determined to obtain the second image feature distance. The second image feature distance indicates an association relation among image features of different training images that do not belong to the same video clip.

In a possible implementation of the embodiments of the disclosure, for example, the selected training images i1 and i2 belong to the same video clip i, and the training images j1 and j2 belong to the same video clip j. The training images i1 and i2 are input into the pre -training module to obtain the image features of respective training images, which are denoted as hi1 and hi2. The training images j1 and j2 are input into the pre-training module to obtain the corresponding image features, denoted as hj1 and hj2, respectively. Further, the inter-class feature distances between the image features of the training images belonging to different video clips i and j are calculated, and then the sum of the inter-class feature distances is determined for at least two video clips selected from the training set in the current round of training in order to obtain the second image feature distance dist(inter), which is specifically realized by the following formula.

$$dist ( inter ) = {\sum }_{i = 1}^{n} {\sum }_{j = 2 , j \neq i}^{n} ( d ( {h}_{i 1} , {h}_{j 1} ) + d ( {h}_{i 1} , {h}_{j 2} ) + d ( {h}_{i 2} , {h}_{j 1} ) + d ( {h}_{i 2} , {h}_{j 2} ) )$$

where, i and j represent different video clips, and n is greater than or equal to 2, d (hᵢ₁, hⱼ₁) is the inter-class feature distance between the image features hi1 and hj1 of the training images in different video clips i and j. d(hᵢ₁, hⱼ₂), d(hᵢ₂, hⱼ₁) and d(hᵢ₂, hⱼ₂) and are inter-class feature distances between the image features of the training images in different video clips i and j.

It should be noted that, in the embodiment, two training images are selected from each video clip. In actual applications, the number of training images selected from each video clip is flexibly set according to training requirements, which is not limited herein.

In another possible implementation of the embodiments of the disclosure, in order to meet requirements of different scenarios, the image features of different training images belonging to different video clips may be classified. That is, the image features of different training images are classified into different categories to achieve refined feature recognition. For example, image features belonging to a category of people, image features belonging to the building, or images features belonging to the nose are determined. For training images belonging to different video clips, an intra-category feature distance between the image features of any two training images that correspond to the same category is obtained. The sum of all the intra-category feature distances is obtained as the inter-class feature distance. Furthermore, for at least two video clips selected from the training set in the round of training, the sum of the inter-class feature distances to obtain the second image feature distance. In this way, a refined calculation of the second image feature distance is realized and a calculation accuracy of the second image feature distance is improved.

It should be noted that the above image feature distance may be calculated according to a Euclidean distance or a cosine distance.

In order to implement the above embodiments, the disclosure provides an image processing apparatus.

FIG. 5 is a block diagram of an image processing apparatus according to an embodiment of the disclosure.

As illustrated in FIG. 5, the apparatus includes an obtaining module 51, a generating module 52 and a processing module 53.

The obtaining module 52 is configured to obtain a pre-training model after a training process based on a plurality of training images, in which image features output by the pre-training model satisfy that a first image feature distance and a second image feature distance have a minimum difference. The first image feature distance is a distance among image features of a plurality of training images extracted from the same video clip, and the second image feature distance is a distance among image features of a plurality of training images extracted from different video clips.

The generating module 52 is configured to generate an image processing model configured to perform a target image processing task based on the pre-training model.

The processing module 53 is configured to perform the target image processing task for a target image by using the image processing model.

In a possible implementation, the generating module 52 is further configured to: obtain a network layer corresponding to the target image processing task; splice the pre-training model with the network layer, in which an input of the network layer is the image features output by the pre-training model, and an output of the network layer is a result of the target image processing task; and generate the image processing model by training the splice version of the pre-training model and the network layer based on a training set of the target image processing task.

In a possible implementation, the target image processing task includes an image classification task, a target detection task or an object recognition task.

It should be noted that the above explanation of the embodiments of the image processing method is also applicable to the image processing apparatus of the embodiments, and the principles thereof are the same, which is not repeated here.

With the image processing apparatus of the embodiments of the disclosure, a pre-training model after a training process based on a plurality of training images is obtained, so that image features output by the pre-training model satisfy that a first image feature distance and a second image feature distance have a minimum difference. Further, according to the general pre-training model and the target image processing task, the corresponding image processing model is generated, which improves a generation efficiency of the image processing model corresponding to the target processing task. The generated image processing model is configured to perform the target image processing task for the target image. Since the image processing model corresponds to the target image processing task, an effect and an efficiency of image processing are improved.

In order to implement the above embodiments, embodiments further provide an apparatus for training a pre-training model.

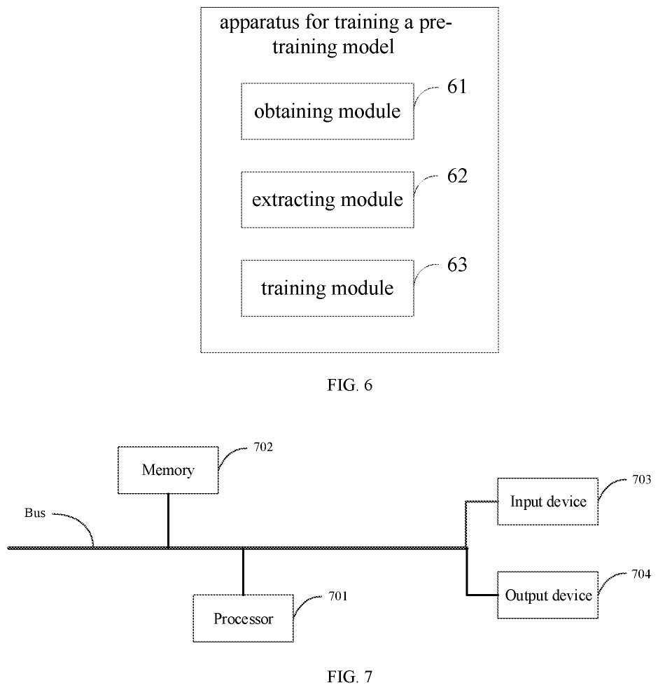

FIG. 6 is a block diagram of an apparatus for training a pre-training model according to an embodiment of the disclosure. As illustrated in FIG. 6, the apparatus includes an obtaining module 61, an extracting module 62 and a training module 63.

The obtaining module 61 is configured to obtain a plurality of video clips. The extracting module 62 is configured to extract a plurality of training images from the plurality of video clips to obtain a training set, in which at least two training images are extracted from each of the plurality of video clips.

The training module 63 is configured to perform a plurality of rounds of training on the pre-training model for image feature extraction based on the training set.

Each round of training includes: selecting training images extracted from at least two video clips from the training set; inputting the selected training images into the pre-training model to obtain image features; determining a first image feature distance among a plurality of training images belonging to a same video clip and determining a second image feature distance among a plurality of training images belonging to different video clips based on the image features of the selected training images, and adjusting parameters of the pre-training model based on the first image feature distance and the second image feature distance to cause that the first image feature distance and the second image feature distance have a minimum difference.

In a possible implementation, the training module 63 is further configured to: for the selected training images inputted into the pre-training model in the round of training process, determine an intra-class feature distance among image features of the plurality of training images belonging to the same video clip; and for the at least two video clips selected from the training set during the round of training process, determine a sum of the intra-class feature distances to obtain the first image feature distance.

In a possible implementation, the training module 63 is further configured to: for the selected training images inputted into the pre-training model in the round of training, determine an inter-class feature distance among the image features of the plurality of training images belonging to different video clips; and for the at least two video clips selected from the training set during the round of training process, determine a sum of the inter-class feature distances to obtain the second image feature distance.

In a possible implementation, a same number of training images are extracted from each video clip.

In a possible implementation, the obtaining module 61 is further configured to: obtain a plurality of videos; and obtain a plurality of video clips of each video by performing segmentation on the video based on a content difference between adjacent images in the video.

With the apparatus for training a pre-training model according to the embodiments of the disclosure, at least two training images are extracted from each of the plurality of video clips, and a plurality of training images are obtained to obtain the training set. Rounds of training are performed on the pre-training model for image feature extraction through the training set. In each round of training, the image features are obtained according to the training images, the first image feature distance among image features is obtained based on the image features of a plurality of training images extracted from the same video clip, and the second image feature distance among image features is obtained based on the image features of a plurality of training images extracted from different video clips. The parameters of the pre-training model are continuously adjusted based on the first image feature distance and the second image feature distance to cause that the first image feature distance and the second image feature distance have a minimum difference. In this way, the training of the general pre-training model is realized and a reliability of the image features recognized by the pre-training model is improved.

In order to implement the above embodiments, the embodiments of the disclosure provide an electronic device. The electronic device includes: at least one processor and a memory communicatively coupled to the at least one processor. The memory stores instructions executable by the at least one processor, and when the instructions are executed by the at least one processor, the at least one processor is caused to execute the image processing method according to the above embodiments or the method for training the pre-training model according to the above embodiments.

In order to implement the above embodiments, the embodiments of the disclosure provide a non-transitory computer-readable storage medium having computer instructions stored thereon. The computer instructions are configured to cause a computer to execute the image processing method according to the embodiments or the method for training the pre-training model according to the embodiments.

According to the embodiments of the disclosure, the disclosure provides an electronic device and a readable storage medium.

FIG. 7 is a block diagram of an electronic device according to an embodiment of the disclosure. Electronic devices are intended to represent various forms of digital computers, such as laptop computers, desktop computers, workbenches, personal digital assistants, servers, blade servers, mainframe computers, and other suitable computers. Electronic devices may also represent various forms of mobile devices, such as personal digital processing, cellular phones, smart phones, wearable devices, and other similar computing devices. The components shown here, their connections and relations, and their functions are merely examples, and are not intended to limit the implementation of the disclosure described and/or required herein.

As illustrated in FIG. 7, the electronic device includes: one or more processors 701, a memory 702, and interfaces for connecting various components, including a high-speed interface and a low-speed interface. The various components are interconnected using different buses and can be mounted on a common mainboard or otherwise installed as required. The processor may process instructions executed within the electronic device, including instructions stored in or on the memory to display graphical information of the GUI on an external input/output device such as a display device coupled to the interface. In other embodiments, a plurality of processors and/or buses can be used with a plurality of memories and processors, if desired. Similarly, a plurality of electronic devices can be connected, each providing some of the necessary operations (for example, as a server array, a group of blade servers, or a multiprocessor system). A processor 701 is taken as an example in FIG. 7.

The memory 702 is a non-transitory computer-readable storage medium according to the disclosure. The memory stores instructions executable by at least one processor, so that the at least one processor executes the method according to the disclosure. The non-transitory computer-readable storage medium of the disclosure stores computer instructions, which are used to cause a computer to execute the method according to the disclosure.

As a non-transitory computer-readable storage medium, the memory 702 is configured to store non-transitory software programs, non-transitory computer executable programs and modules, such as program instructions/modules (for example, the obtaining module 51, the generating module 52, and the processing module 53 shown in FIG. 5) corresponding to the method in the embodiments of the disclosure. The processor 701 executes various functional applications and data processing of the electronic device by running non-transitory software programs, instructions, and modules stored in the memory 702, that is, implementing the method in the foregoing method embodiments.

The memory 702 may include a storage program area and a storage data area, where the storage program area may store an operating system and application programs required for at least one function. The storage data area may store data created according to the use of the electronic device for implementing the method. In addition, the memory 702 may include a high-speed random access memory, and a non-transitory memory, such as at least one magnetic disk storage device, a flash memory device, or other non-transitory solid-state storage device. In some embodiments, the memory 702 may optionally include a memory remotely disposed with respect to the processor 701, and these remote memories may be connected to the electronic device for implementing the method through a network. Examples of the above network include, but are not limited to, the Internet, an intranet, a local area network, a mobile communication network, and combinations thereof.

The electronic device used to implement the image processing method may further include: an input device 703 and an output device 704. The processor 701, the memory 702, the input device 703, and the output device 704 may be connected through a bus or in other manners. In FIG. 7, the connection through the bus is taken as an example.

The input device 703 may receive inputted numeric or character information, and generate key signal inputs related to user settings and function control of an electronic device for implementing the method, such as a touch screen, a keypad, a mouse, a track pad, a touchpad, an indication rod, one or more mouse buttons, trackballs, joysticks and other input devices. The output device 704 may include a display device, an auxiliary lighting device (for example, an LED), a haptic feedback device (for example, a vibration motor), and the like. The display device may include, but is not limited to, a liquid crystal display (LCD), a light emitting diode (LED) display, and a plasma display. In some embodiments, the display device may be a touch screen.

Various embodiments of the systems and technologies described herein may be implemented in digital electronic circuit systems, integrated circuit systems, application specific integrated circuits (ASICs), computer hardware, firmware, software, and/or combinations thereof. These various embodiments may be implemented in one or more computer programs, which may be executed and/or interpreted on a programmable system including at least one programmable processor. The programmable processor may be dedicated or general purpose programmable processor that receives data and instructions from a storage system, at least one input device, and at least one output device, and transmits the data and instructions to the storage system, the at least one input device, and the at least one output device.

These computing programs (also known as programs, software, software applications, or code) include machine instructions of a programmable processor and may utilize high-level processes and/or object-oriented programming languages, and/or assembly/machine languages to implement these calculation procedures. As used herein, the terms “machine-readable medium” and “computer-readable medium” refer to any computer program product, device, and/or device used to provide machine instructions and/or data to a programmable processor (for example, magnetic disks, optical disks, memories, programmable logic devices (PLDs), including machine-readable media that receive machine instructions as machine-readable signals. The term “machine-readable signal” refers to any signal used to provide machine instructions and/or data to a programmable processor.

In order to provide interaction with a user, the systems and techniques described herein may be implemented on a computer having a display device (e.g., a Cathode Ray Tube (CRT) or a Liquid Crystal Display (LCD) monitor for displaying information to a user); and a keyboard and pointing device (such as a mouse or trackball) through which the user can provide input to the computer. Other kinds of devices may also be used to provide interaction with the user. For example, the feedback provided to the user may be any form of sensory feedback (e.g., visual feedback, auditory feedback, or haptic feedback), and the input from the user may be received in any form (including acoustic input, voice input, or tactile input).

The systems and technologies described herein can be implemented in a computing system that includes background components (for example, a data server), or a computing system that includes middleware components (for example, an application server), or a computing system that includes front-end components (For example, a user computer with a graphical user interface or a web browser, through which the user can interact with the implementation of the systems and technologies described herein), or include such background components, intermediate computing components, or any combination of front-end components. The components of the system may be interconnected by any form or medium of digital data communication (egg, a communication network). Examples of communication networks include: local area network (LAN), wide area network (WAN), and the Internet.

The computer system may include a client and a server. The client and server are generally remote from each other and interacting through a communication network. The client-server relation is generated by computer programs running on the respective computers and having a client-server relation with each other. The server may be a cloud server, also known as a cloud computing server or a cloud host, which is a host product in the cloud computing service system to solve management difficulty and weak business scalability defects of traditional physical hosts and Virtual Private Server (VPS) services.

According to the technical solution of the embodiments of the disclosure, a pre-training model is obtained. The pre-training model goes through a training process based on the plurality of training images, so that the image features output by the pre-training model satisfy that a first image feature distance and a second image feature distance have a minimum difference. Further, according to the general pre-training model and the target image processing task, the corresponding image processing model is generated, which improves a generation efficiency of the image processing model corresponding to the target processing task. The generated image processing model is configured to perform the target image processing task for the target image. Since the image processing model corresponds to the target image processing task, an effect and an efficiency of image processing are improved.

It should be noted that the electronic device implements the method for training a pre-training model of the disclosure, which has the same principle as the corresponding method, and the details are not repeated here.

It should be understood that the various forms of processes shown above can be used to reorder, add or delete steps. For example, the steps described in the disclosure could be performed in parallel, sequentially, or in a different order, as long as the desired result of the technical solution disclosed in the disclosure is achieved, which is not limited herein.

The above specific embodiments do not constitute a limitation on the protection scope of the disclosure. Those skilled in the art should understand that various modifications, combinations, sub-combinations and substitutions can be made according to design requirements and other factors. Any modification, equivalent replacement and improvement made within the spirit and principle of this application shall be included in the protection scope of this application.

What is claimed is:

1. An image processing method, comprising:
obtaining a pre-training model after a training process based on a plurality of training images, wherein image features output by the pre-training model satisfy that a first image feature distance and a second image feature distance have a minimum difference, wherein the first image feature distance is a distance among image features of a plurality of training images extracted from a same video clip, and the second image feature distance is a distance among image features of a plurality of training images extracted from different video clips;
generating an image processing model based on the pre-training model, wherein the image processing model is configured to perform a target image processing task; and
performing the target image processing task for a target image by using the image processing model.

2. The method according to claim 1, wherein generating the image processing model based on the pre-training model comprises:
obtaining a network layer corresponding to the target image processing task based on a predetermined correspondence between network layers and target image processing tasks;
splicing the pre-training model with the network layer, wherein an input of the network layer is the image features output by the pre-training model, and an output of the network layer is a result of the target image processing task; and
generating the image processing model by training a splice version of the pre-training model and the network layer based on a training set of the target image processing task.

3. The method according to claim 1, wherein the target image processing task comprises an image classification task, a target detection task or an object recognition task.

4. The method according to claim 1, wherein the training process comprises:
obtaining a plurality of video clips;
extracting a plurality of training images from the plurality of video clips to obtain a training set, wherein at least two training images are extracted from each video clip; and
performing a plurality of rounds of training based on the training set to obtain the pre-training model for image feature extraction;
wherein each round of training comprises: selecting training images extracted from at least two video clips from the training set; inputting the selected training images into the pre-training model to obtain image features; determining the first image feature distance among a plurality of training images belonging to a same video clip and determining the second image feature distance among a plurality of training images belonging to different video clips based on the image features of the selected training images, and adjusting parameters of the pre-training model based on the first image feature distance and the second image feature distance to cause that the first image feature distance and the second image feature distance have the minimum difference.

5. The method according to claim 4, wherein determining the first image feature distance among the plurality of training images belonging to the same video clip comprises:
for the selected training images inputted into the pre-training model in the round of training, determining an intra-class feature distance among image features of the plurality of training images belonging to the same video clip; and
for the at least two video clips selected from the training set during the round of training, determining a sum of the intra-class feature distances to obtain the first image feature distance.

6. The method according to claim 4, wherein determining the second image feature distance among the plurality of training images belonging to different video clips comprises:
for the selected training images inputted into the pre-training model in the round of training, determining an inter-class feature distance among the image features of the plurality of training images belonging to different video clips; and
for the at least two video clips selected from the training set during the round of training, determining a sum of the inter-class feature distances to obtain the second image feature distance.

7. The method according to claim 4, wherein a same number of training images are extracted from each video clip.

8. The method according to claim 4, wherein obtaining the plurality of video clips comprises:
obtaining a plurality of videos; and
obtaining a plurality of video clips of each video by performing segmentation on the video based on a content difference between adjacent images in the video.

9. A method for training a pre-training model, comprising:
obtaining a plurality of video clips;
extracting a plurality of training images from the plurality of video clips to obtain a training set, wherein at least two training images are extracted from each video clip; and
performing a plurality of rounds of training on the pre-training model for image feature extraction based on the training set;
wherein each round of training comprises: selecting training images extracted from at least two video clips from the training set; inputting the selected training images into the pre-training model to obtain image features; determining a first image feature distance among a plurality of training images belonging to a same video clip and determining a second image feature distance among a plurality of training images belonging to different video clips based on the image features of the selected training images, and adjusting parameters of the pre-training model based on the first image feature distance and the second image feature distance to cause that the first image feature distance and the second image feature distance have a minimum difference.

10. The method according to claim 9, wherein determining the first image feature distance among the plurality of training images belonging to the same video clip comprises:
for the selected training images inputted into the pre-training model in the round of training, determining an intra-class feature distance among image features of the plurality of training images belonging to the same video clip; and
for the at least two video clips selected from the training set during the round of training, determining a sum of the intra-class feature distances to obtain the first image feature distance.

11. The method according to claim 9, wherein determining the second image feature distance among the plurality of training images belonging to different video clips comprises:
for the selected training images inputted into the pre-training model in the round of training, determining an inter-class feature distance among the image features of the plurality of training images belonging to different video clips; and
for the at least two video clips selected from the training set during the round of training, determining a sum of the inter-class feature distances to obtain the second image feature distance.

12. The method according to claim 9, wherein a same number of training images are extracted from each video clip.

13. The method according to claim 9, wherein obtaining the plurality of video clips comprises:
obtaining a plurality of videos; and
obtaining a plurality of video clips of each video by performing segmentation on the video based on a content difference between adjacent images in the video.

14. An electronic device, comprising
at least one processor; and
a memory communicatively coupled to the at least one processor;
wherein, the memory stores instructions executable by the at least one processor, and when the instructions are executed by the at least one processor, the at least one processor is caused to execute the image processing method comprising:
obtaining a pre-training model after a training process based on a plurality of training images, wherein image features output by the pre-training model satisfy that a first image feature distance and a second image feature distance have a minimum difference, wherein the first image feature distance is a distance among image features of a plurality of training images extracted from a same video clip, and the second image feature distance is a distance among image features of a plurality of training images extracted from different video clips;
generating an image processing model based on the pre-training model, wherein the image processing model is configured to perform a target image processing task; and
performing the target image processing task for a target image by using the image processing model.

15. The device according to claim 14, wherein generating the image processing model based on the pre-training model comprises:
obtaining a network layer corresponding to the target image processing task based on a predetermined correspondence between network layers and target image processing tasks;
splicing the pre-training model with the network layer, wherein an input of the network layer is the image features output by the pre-training model, and an output of the network layer is a result of the target image processing task; and
generating the image processing model by training a splice version of the pre-training model and the network layer based on a training set of the target image processing task.

16. The device according to claim 14, wherein the target image processing task comprises an image classification task, a target detection task or an object recognition task.

17. The device according to claim 14, wherein the training process comprises:
obtaining a plurality of video clips;
extracting a plurality of training images from the plurality of video clips to obtain a training set, wherein at least two training images are extracted from each video clip; and
performing a plurality of rounds of training based on the training set to obtain the pre-training model for image feature extraction;
wherein each round of training comprises: selecting training images extracted from at least two video clips from the training set; inputting the selected training images into the pre-training model to obtain image features; determining the first image feature distance among a plurality of training images belonging to a same video clip and determining the second image feature distance among a plurality of training images belonging to different video clips based on the image features of the selected training images, and adjusting parameters of the pre-training model based on the first image feature distance and the second image feature distance to cause that the first image feature distance and the second image feature distance have the minimum difference.

18. The device according to claim 17, wherein determining the first image feature distance among the plurality of training images belonging to the same video clip comprises:
for the selected training images inputted into the pre-training model in the round of training, determining an intra-class feature distance among image features of the plurality of training images belonging to the same video clip; and
for the at least two video clips selected from the training set during the round of training, determining a sum of the intra-class feature distances to obtain the first image feature distance.

19. The device according to claim 17, wherein determining the second image feature distance among the plurality of training images belonging to different video clips comprises:
for the selected training images inputted into the pre-training model in the round of training, determining an inter-class feature distance among the image features of the plurality of training images belonging to different video clips; and
for the at least two video clips selected from the training set during the round of training, determining a sum of the inter-class feature distances to obtain the second image feature distance.

20. The device according to claim 17, wherein obtaining the plurality of video clips comprises:
obtaining a plurality of videos; and
obtaining a plurality of video clips of each video by performing segmentation on the video based on a content difference between adjacent images in the video.
